(19) United States
(12) Patent Application Publication
(10) Pub. No.: US 2004/0173165 A1
(43) Pub. Date: Sep. 9, 2004

(54) Methods for controlling direct start of an internal combustion engine

(76) Inventors: Udo Sieber, Bietigheim (DE); Jochen Laubender, Stuttgart (DE); Andre-Francisco Casal Kulzer, Boeblingen (DE)

Correspondence Address: STRIKER, STRIKER & STENBY, 103 East Neck Road, Huntington, NY, 11743, US

(21) Appl. No.: 10/775,787

(22) Filed: Feb. 10, 2004

(30) Foreign Application Priority Data
Feb. 14, 2003 (DE) 103 06 145.2

(51) Int. Cl. F02B 43/10; F02N 17/04

(52) U.S. Cl. 123/3; 123/179.21

(57) ABSTRACT

The method for direct start of an internal combustion engine with direct fuel injection into combustion chambers of the engine that are filled with air includes improving or increasing fuel vaporization in the combustion chambers when a start temperature (T) of the internal combustion engine is below a predetermined start temperature threshold (T_S). The apparatus for performing the method includes a control unit (20) for controlling direct start of the internal combustion engine.

### BACKGROUND OF THE INVENTION

1. Field of the Invention

The present invention relates to methods for direct start of an internal combustion engine with direct fuel injection into the combustion chambers of the internal combustion engine filled with air.

2. Description of the Related Art

Conventional internal combustion engines with direct injection can be started during cold start only an electrical starter operated together with an increased fuel injection rate, because the mixture preparation in the cylinders is insufficient because of the cold temperatures. For compensation the fuel amounts, which deposit on the cold cylinder and/or piston walls as fuel film, are replaced by measured metered multiple amounts during individual injection events, in order to provide sufficient fuel for mixing with the cold air in the cylinders for predetermined mixture compositions (lambda=1; <1; or >1).

However during cold start the fuel film on the cylinder and piston walls cannot or only incompletely vaporize and thus does not participate directly in the combustion. This leads to increased HC emissions in the exhaust gas in subsequent exhaust strokes or cycles, which cannot be sufficiently converted by the still cold catalytic converter. Furthermore the specific fuel consumption of the vehicle is considerably increased because of the multiple amounts of fuel required for cold start. The poor mixture preparation or mixing and the increased motor oil viscosity also are principal causes for slower motor speed at the desired idle speed in cold start than in a start with an internal combustion engine that is already warm from previous operation.

Methods are known for starting the internal combustion engine with direct injection, which put the internal combustion engine into operation without an electric starter motor. For this purpose an amount of fuel required for combustion during idle of the internal combustion engine is injected and ignited into combustion chambers, whose associated pistons are in the operating position.

This sort of internal combustion engine and its methods are disclosed in DE 197 43 492 A1.

Especially in internal combustion engines with direct injection and with a start-stop operability based on it, the above-described conditions produce great problems for starting processes at low temperatures.

The essential result of this sort of start depends on the mixing process in the cold combustion chambers, in which an ignitable fuel/air mixture should result from the air enclosed in the combustion chamber in the idle state with the injected fuel. With insufficient mixing the mixture cannot be ignited in the extreme case. There is a danger that the injected fuel mass is only partially burned, even in the case of a successful ignition so that only an insufficient torque is produced. These problems have a great importance particularly during a cold start because of the cold air in the cylinder and because of the cold cylinder and piston walls. In addition to these effects, which reduce the torque resulting from the combustion, the internal combustion engine requires an elevated torque during cold start for accelerating and permitting rotation speed increase during cold start because of the increased motor oil viscosity and the increased friction losses caused by it.

### SUMMARY OF THE INVENTION

For the foregoing reasons it is an object of the present invention to provide a method for direct start of an internal combustion engine, which permits start-stop operation of the internal combustion engine operating with direct fuel injection even at low temperature, in which it is guaranteed that the combustion energy overcomes the required compression work and higher friction work so that the engine can be rapidly and reliably started without impairing traffic flow.

It is another object of the present invention to provide a control unit, which controls the method of operating the internal combustion engine according to the invention.

These objects and others, which will be made more apparent hereinafter, are attained in a method of the above-described kind for direct start of an internal combustion engine with direct fuel injection into at least one combustion chamber of the engine, which is filled with air.

According to the invention the method comprises at least one step for improving or increasing fuel vaporization in the at least one combustion chamber when the start temperature is below a predetermined start temperature threshold.

The above-described objects of the invention are attained when the fuel vaporization in the combustion chambers is improved or increased by the steps or measures according to the invention. These features provide targeted help for the above-described problems, especially during extended start-stop operation, in which extended “stop and go” operation of the vehicle takes place, even at low temperatures under zero degrees Celcius. When this sort of direct start cannot be performed in spite of the features for improving the fuel vaporization according to the invention, the invention at least facilitates a successful cold starting process with only a minimal use of a starting aid, for example an electric starter.

These advantages are achieved because improved mixing in the combustion chambers takes place because of improved vaporization of fuel droplets. Greater amounts of the injected fuel are burned during the following ignitions. As a result, the torque that is produced is improved.

Because of the better mixing the required multiple fuel amounts for cold start are clearly reduced or even eliminated.

In a preferred embodiment the at least one step for improving fuel vaporization according to the invention includes increasing the combustion temperature in the at least one combustion chamber prior to direct start.

This embodiment has the advantage that a wall fuel film, which still necessarily builds up during fuel injection despite reduced cold start fuel amounts, rapidly vaporizes at elevated combustion temperatures. The fuel vapor is thus supplied to the combustion process and does not subsequently reach the surrounding air as unburned HC in the exhaust cycle or stroke. The emissions of the internal combustion engine are thus clearly reduced.

In preferred embodiments of the method for direct start of the internal combustion engine the at least one step for increasing the combustion temperature in the at least one combustion chamber includes at least one of the following during cold start:

supplying pre-heated air to the at least one combustion chamber of the engine;

activating a heating device arranged in at least one cylinder head;

activating another heating device arranged in the cylinder walls of the internal combustion engine;

circulating a cooling medium with a circulating pump in an engine cooling water circulation and heating the cooling water circulation; and

heating of at least one piston base or bottom of at least one piston.

These embodiments have the advantage that they directly counter wall film formation, since the evaporation in each case increases with the increased wall temperature and simultaneously reduces the condensation of the fuel. Local heating of the motor oil occurs in each case in the vicinity of the combustion chamber as an additional effect, which reduces the required torque for overcoming the static friction.

In other preferred embodiments of the invention the fuel injected into the combustion chambers of the engine is heated prior to injection.

Because of these features an especially rapid and energy efficient increase in the fuel evaporation results, since only little mass is heated and the supplied heat is directly fed to the fuel to be vaporized.

In additional preferred embodiments the method for direct start according to the invention includes heating injector valves and/or of other parts through which fuel is supplied.

These additional embodiments of the method contribute to the above-described advantages, since heating of the injector valves immediately before the combustion chambers keeps the loss of heat energy from pre-heated fuel supplied to the combustion chambers as small as possible.

In further preferred embodiments the lubricant circulation in the internal combustion engine is also heated.

This latter feature reduces the viscosity of the lubricant and thus decreases the internal friction losses, which reduce the torque required during starting in a desirable manner.

Additional preferred embodiments provide that the features or steps for improving fuel vaporization are activated prior to starting the internal combustion engine.

Thus it is preferred that the features or steps are put into operation by a procedure, which is necessary for the start and takes place prior to the start.

It is especially preferred in this connection that the features or steps of the method are activated by a radio remote control signal for opening a door of the motor vehicle in which the internal combustion engine is located.

Because of this latter feature the first start can already benefit from the above-described steps or measures. Especially the activation by the radio remote control signal provides that the time, during which the heating features are available prior to the start, is as large as possible. Principally the heating features can be activated at an arbitrary predefined time.

It is also preferred that at least one starting fuel is injected during the first injection occurring for a direct start. This starting fuel has a vapor pressure that is higher than that of the fuel injected subsequently for additional or normal operation of the engine.

The use of fuel with greater vapor pressure and/or with a greater fraction of volatile components (such as HC or alcohol components) leads directly to a greater vaporization and thus to improved mixture formation. This starting fuel is exclusively used at the start of the operation of the internal combustion engine. Subsequently operation of the engine is switched back to conventional fuel.

For example, hydrogen can be used, for example, as the starting fuel. The hydrogen employed can be produced from water during travel by an on-board electrolysis performed in the vehicle. The hydrogen can be stored for subsequent starting events in a pressurized tank and burned with oxygen from the surrounding air during starting events. Alternatively or in addition to air oxygen, oxygen, which is produced during electrolysis of water and stored in another pressurized tank, can also be supplied for combustion of hydrogen.

The use of volatile starting fuel with a high vapor pressure has the advantage that it is already largely present at ambient pressure in the vaporization stage, as it is present prior to the starting process in the cylinder. The starting fuel more easily vaporizes the inevitable wall film on the cylinder and piston walls and thus can be supplied faster to the combustion process than the conventional or normal fuel. This feature reduces both the starting emissions and also the specific fuel consumption of the internal combustion engine.

It is further preferred that first a combustion event is activated in a cylinder, which is in a compression stroke or cycle, in an internal combustion engine with several cylinders so that the engine crankshaft is rotated in a direction opposite to its normal direction. This causes compression in another cylinder, which is in its working cycle. Then combustion occurs in this latter cylinder, which accelerates the crankshaft in its normal rotation direction.

This embodiment of the method for direct start causes compression and thus an inherent temperature increase of the charge in the cylinder in its working cycle. Motion of the charge in the combustion chamber is obtained by the compression in addition to the heating. Both effects together, by heating and motion, improve the mixture preparation in this cylinder considerably, so that this cylinder produces a more powerful torque already during a first combustion process or event in it. Thus the internal combustion engine can also be started in a cold state without or with reduced assistance from an additional electrostarter.

In a preferred embodiment the injections into the cylinders, which are found in the compression cycle and the working cycle, are adjusted with respect to the amount of fuel injected so that the cylinder produces greater torque in its working cycle. Also the ignition is controlled accordingly in the concerned cylinders.

It is also preferable that the control unit for controlling a direct start of the internal combustion engine performs a control of at least one of the above-described processes.

As an additional alternative the above-described features or steps of the method can be combined with each other, so that in combination they contribute directly to especially effective extended start-stop operation of the engine at low temperature.

As an additional alternative the above-described features or steps can be used in systems with direct start and start-stop operation individually or together with a multiple injection of fuel in the pre-starting phase.

Furthermore these feature or step and their combinations can also be used in an internal combustion engine without direct fuel injection, in order to improve the starting process at low temperature.

It should be understood that the above-describe features or measures and the features explained in more detail in the following detailed description can be used not only in the described combinations, but also in other combinations or alone, without going beyond the scope of the present invention.

### BRIEF DESCRIPTION OF THE SEVERAL VIEWS OF THE DRAWING

The objects, features and advantages of the invention will now be illustrated in more detail with the aid of the following description of the preferred embodiments, with reference to the accompanying figures in which:

FIG. 1 is a schematic total, partially sectional view of an internal combustion engine together with means for improving fuel vaporization according to the invention in the combustion chamber of the engine;

FIG. 2 is a simplified block diagram of one embodiment of a method for direct start of an internal combustion engine according to the invention;

FIG. 3 is a block diagram of an alternative or complementary embodiment of the method for direct start according to the invention; and

FIGS. 4a, 4b, 4c and 4d are respective diagrammatic perspective views showing different positions of pistons in cylinders of an internal combustion engine during the performance of the embodiment of the method according to the invention shown in FIG. 3.

### DETAILED DESCRIPTION OF THE INVENTION

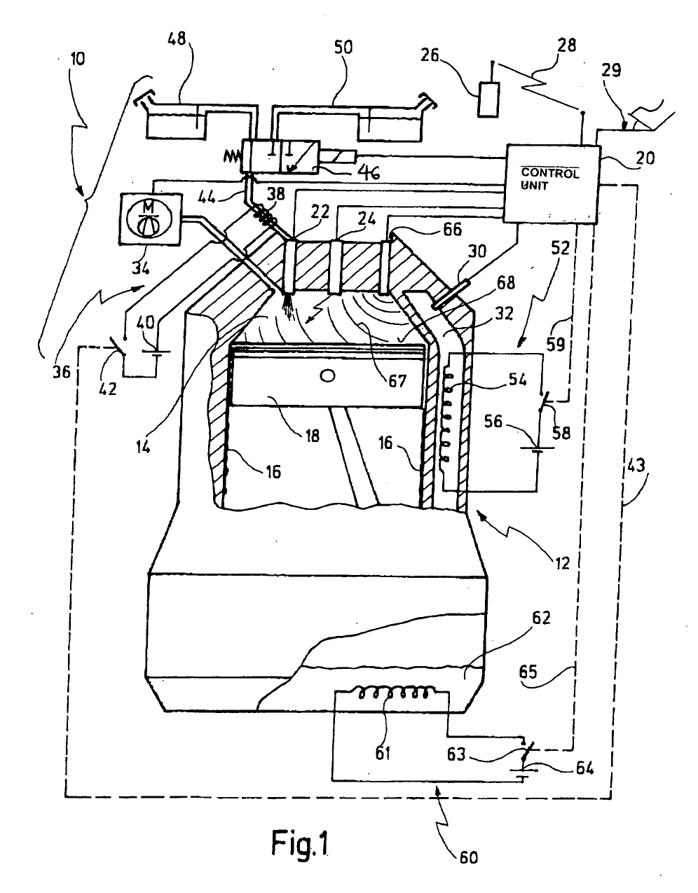

The reference number 10 in FIG. 1 designates an entire internal combustion engine 12 with at least one combustion chamber 14, which is moveably sealed by a piston 18 sliding on an oil film 16. The charge in the combustion chamber 14 is exchanged by means of gas exchange valves, which are not shown in FIG. 1 in order to simplify illustration. A control unit 20 controls operation of the internal combustion engine 12, especially direct start of the internal combustion engine 12. Also the control unit 20 controls at least one injector valve 22 and a spark plug 24 for each combustion chamber 14.

To simplify direct start of the internal combustion engine 12 the control unit 20 initiates or activates at least one step or feature for improving vaporization of fuel in the combustion chamber 14. Also the control unit 20 can be activated in a first starting event with the help of a remote controller 26, which transmits a suitable signal 28 to the control unit 20. The remote controller 26 can, for example, be a radio remote control, with which the doors of the vehicle are opened. Because of that the control unit 20 can already activate the at least one feature or step for improving vaporization of fuel in the combustion chambers 14 of the engine 12 prior to starting of the engine 12. Thus the effects of these features or steps can already be present during subsequent starting of the engine 12. Understandably the activation of these steps or features for a first start of the engine is not limited to activation by a radio remote control for opening the doors. Many more features or steps, which take place prior to the start of the engine 12, are also suitable. Thus e.g. the opening of a door by a door contact switch can be monitored or a seat contact switch can detect the weight of the driver, so that functions according to the method of the invention can be initiated. Alternatively the insertion of an ignition key in an ignition lock or other steps, which the driver of the vehicle can perform in connection with starting the internal combustion engine 12, can be used to activate the functions according to the invention for improving fuel vaporization.

After a first start other starts are activated in a start-stop operation, for example by a signal of a sensor 29, which is coupled with an accelerator pedal, a clutch pedal or switch lever of the motor vehicle and detects motions, positions and contacts of these parts.

The control unit 20 activates the steps or features according to the invention, when the starting temperature of the internal combustion engine 12 is below a predetermined threshold value. To detect this state or condition the signal of a temperature sensor 30 can be input to the control unit 20. The sensor 30 can be arranged in a cooling jacket 32 of the internal combustion engine 12. Alternatively however a lubricant temperature sensor or modeling of the temperature of internal combustion engine 12, which is based on a previous operating stage of the engine 12 at a certain time interval, can be used. Also the temperature of the air intake of the engine 12 can be called upon at least in a supplementary manner to active operations or functions according to the invention, since the steps or features according to the invention should be performed especially with low air intake temperatures.

The features according to the invention can include blowing heated air from a hot air blower 34 into the combustion chamber 14. This feature is especially of advantage when the injector valve 22 of the internal combustion engine 12 is constructed as a so-called surrounding air injector valve. In this surrounding air injector valve 22 the atomization of the injected fuel is improved further by blowing air in parallel to the fuel. The use of surrounding air for blowing in warmer air improves the vaporization of fuel in the combustion chamber 14 prior to a direct start of the internal combustion engine 12, without the need to make greater structural changes in the internal combustion engine 12. It is only necessary to provide a device for heating air, which is not shown individually in detail in FIG. 1, but is integrated in the hot air blower 34.

Alternatively or additionally the fuel injected by the injector valve 22 into the combustion chamber 14 can be pre-heated by a fuel pre-heater 36. The fuel pre-heater 36 includes a heating coil 38, which is either integrated in the injector valve 22 or the fuel line 44 for supplying fuel to the injector valve 22 as close as possible to the injector valve 22. The fuel pre-heater 36 also has a current supply 40, which is coupled by a switch 42 with the heating coil 38. The switch 42 is operated by the dashed working connection 43 from the control unit 20.

Additionally or alternatively the steps or features for improving the evaporation or vaporization of fuel in the combustion chamber 14 of the internal combustion engine 12 also include the use of a special starting fuel. This special starting fuel is characterized by a higher vapor pressure in comparison to normal fuel and thus an inherently higher vaporization rate. For that reason it is used to start the internal combustion engine 12. For this purpose in a preferred embodiment of the invention the fuel supply line 44 to the injector valve 22 can be alternately connected with a first fuel tank 48 or a second fuel tank 50 by means of a controllable 3-way valve 46. The controllable three-way valve 46 supplies the injector valve 22 with starting fuel from the first fuel tank 48. After a successful start the control unit 20 controls the 3-way valve 46, so that the fuel supply line 44 is no longer connected to the first fuel tank 48, but instead to the second fuel tank 50, which contains the fuel for normal operation of the engine 12. To remove normal fuel still remaining in the fuel line supply line 44 when switching from normal fuel from the second fuel tank 50 to starting fuel from the first fuel tank 48, a return line can be provided from the injector valve 22 to the second fuel tank 50. The return line, which is not shown in FIG. 1, permits rinsing the fuel supply line 44 with starting fuel.

Further alternatively or additionally the features or steps for improving fuel vaporization in the combustion chamber can include features for heating the combustion chamber 14 by heat transfer. The cooling means pre-heater 52 can be provided, which contains a heating coil 54 arranged in cooling jacket 32 of the engine 12. Heating coil 54 is connected to a current supply 56, wherein the circuit is closed or opened by switch 58, which is operated by the control unit 20 via working connection 59. Alternative to arranging this sort of heating in the cooling jacket of the cylinder it can be arranged also in the cylinder head.

Also alternatively or additionally a lubricant pre-heater 60 can be used, which includes heating coil 61, which, for example, can be arranged in an oil pan or an oil sump 62 of the internal combustion engine 12. Heating coil 61 is connected with a current supply by means of a switch 63, wherein the switch 63 is operated by control unit 20 by the working connection 65. The working connections 43, 59 and 65 for example can be formed as separate lines or bus connections and the current supplies 40, 56 and 64 can comprise a single unit, for example, an individual battery.

A microwave transmitter or ultrasonic transmitter 66 can function as a further means for improving the fuel vaporization in the combustion chamber 14. This microwave transmitter or ultrasonic transmitter 66 emits microwaves or ultrasonic waves 67 into the combustion chamber 14 of the internal combustion engine 12, whose energies, for example, are absorbed by microwave-sensitive or ultrasonic-wave-sensitive coating 68 on the piston bottom and thus heat the piston. This sort of coating can also cover the walls of the combustion chamber 14, so that alternatively or in addition to microwave heating of the piston bottom also the walls of the combustion chamber 14 can be heated up with microwave energy or ultrasonic energy.

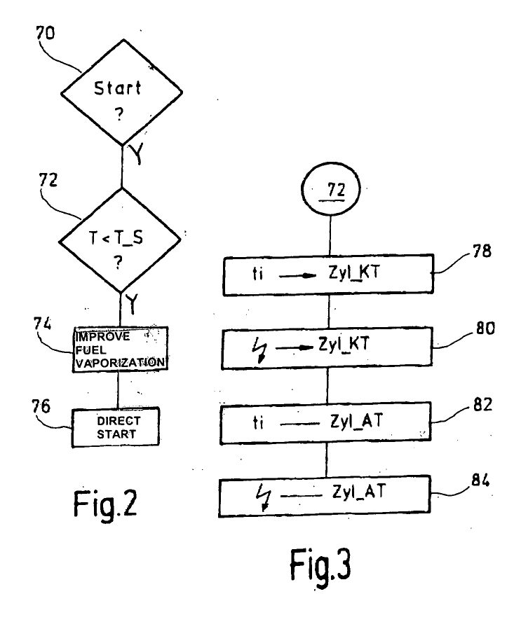

FIG. 2 illustrates a simplified method for direct start of an internal combustion engine according to the invention with a block diagram. In a step 70 whether or not the internal combustion engine should be started is tested. This question is answered “yes”, Y, when the internal combustion engine is idle and the radio remote control 26 generates a signal 28. If this signal or another signal activating a start is present, in step 72 the temperature conditions are tested. The steps or features of the method for improving fuel vaporization are then activated, when the temperature, T, of the internal combustion engine 12 is below a predetermined threshold value, T_S. If this is the case, Y, in step 74 at least one feature or step for improving fuel vaporization in combustion chamber 14, for example one of the features described in connection with FIG. 1, is activated. Subsequently in step 76 a direct start is performed without the assistance of an electrostarter by injecting fuel into the combustion chamber 14 of the internal combustion engine 12 and subsequently igniting the charge in the combustion chamber 14.

FIG. 3 show an additional embodiment according to the invention for improving fuel vaporization in combustion chamber 14 of the engine 12. The embodiment of FIG. 3 can be used alternatively or in addition to the previously described features of FIG. 2. The steps of the block diagram according to FIG. 3 are reached from step 72, which is already described in connection with FIG. 2. Subsequently in step 78 first an injector valve of a cylinder of the engine 12, whose piston is in a compression position, is controlled with an injection pulse width ti. In the following step 80 the ignitable fuel/air mixture filled in that combustion chamber is ignited. Because of that a first combustion occurs in that cylinder in a compression stroke, not in a working stroke. This combustion event produces a torque, which drives a crankshaft of the engine 12 opposite to its normal rotation direction. These steps result in a compression of charge in the cylinder, which is found in a working stroke during engine idle. This compression moves the air mass in this cylinder 98 and heats it. During or after the compression a fuel injection into this cylinder takes place under control of the injector valve with an injection pulse width ti in step 82. Since this injection occurs in a moving heated charge with air, a very good vaporization of the injected fuel is obtained. Subsequently the good charge in the combustion chamber of that cylinder, which is still in the working stroke, is ignited so that the torque resulting from combustion of this charge accelerates the crankshaft of the engine 12 in its normal rotation direction. By appropriate control of the respective injection amounts and ignition time points this second combustion event provides considerably more torque than the first combustion, so that the internal combustion engine 12 runs as a result in its normal correct rotation direction.

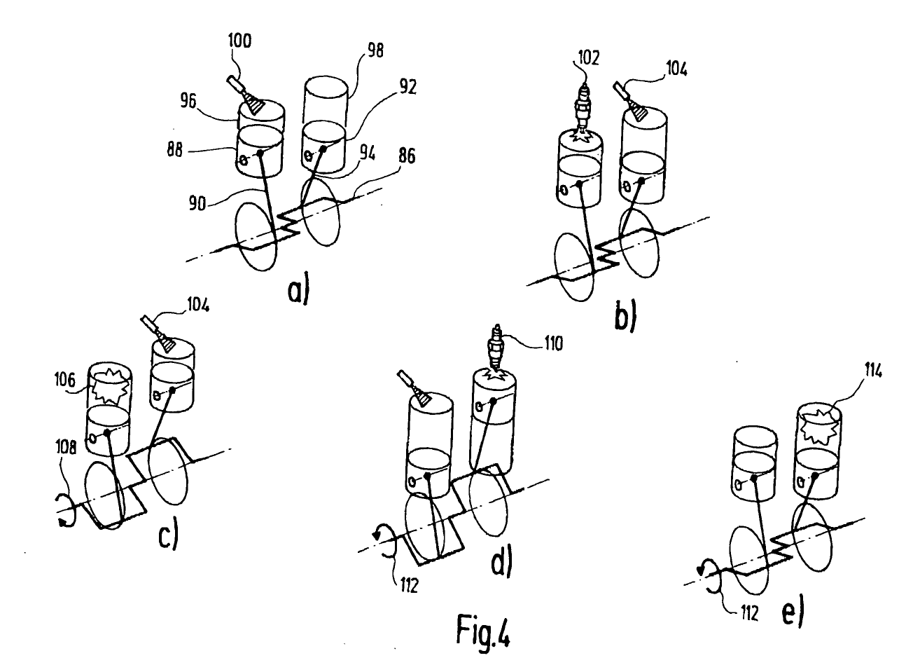

These steps of the method are illustrated and described in the following in connection with FIGS. 4a to 4d. FIG. 4a shows a crankshaft 86 of an internal combustion engine 12 from FIG. 1, to which a first piston 88 and a second piston 92 are pivotally connected by means of a first piston rod 90 and a second piston rod 94 respectively. The first piston 88 reciprocates in a first cylinder 96 and the second piston 92 reciprocates in a second cylinder 98. In FIG. 4a the crankshaft 86 is idle and the first piston 88 is found in a compression position, while the second piston 92 stands in the second cylinder 98 in a working cycle position. By injection into the first cylinder 96, which is found in a compression position, by means of an injector valve 100, a combustible fuel/air mixture is produced, which is subsequently ignited by a first spark plug 102, as illustrated in FIG. 4b. At the same time as the ignition of the charge in the first cylinder 96 injection of fuel into the second cylinder 98 occurs by means of a second injector valve 104.

In FIG. 4c next the crankshaft 86 is rotated by a first combustion event 106 in the first cylinder 96 in a direction shown by the arrow 108. Because this rotation direction is opposite to the normal rotation direction of the crankshaft 86, the second piston 92 moves up in the second cylinder 98 and compresses the combustible charge in this cylinder.

Subsequently, as illustrated in FIG. 4d, the combustible charge in second cylinder 98, which was well prepared by the foregoing compression, is ignited with the help of second spark plug 110. The ignition occurs at a time point, which causes a torque on the crankshaft 86 resulting from the combustion 114 of the combustible charge in the second cylinder so that it is accelerated in its normal rotation direction. Because of the foregoing compression the mixture preparation in the in the second cylinder is so good that the combustion event 114 produces a very forceful torque, which subsequently drives the motor further in its normal rotation direction.

The disclosure in German Patent Application 103 06 145.2 of Feb. 14, 2003 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in methods of controlling direct start of an internal combustion engine, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A method for direct start of an internal combustion engine with direct fuel injection into at least one combustion chamber of the engine that is filled with air, wherein said method comprises at least one step for improving or increasing fuel vaporization in said at least one combustion chamber when a start temperature (T) of the internal combustion engine is below a predetermined start temperature threshold (T_S).

2. The method as defined in claim 1, wherein said at least one step includes increasing a combustion temperature in said at least one combustion chamber prior to said direct start.

3. The method as defined in claim 2, wherein said combustion temperature is increased by at least one of the following:
supplying pre-heated air to said at least one combustion chamber of the engine;
activating a heating device arranged in at least one cylinder head of the engine;
activating another heating device arranged in cylinder walls of the engine;
circulating a cooling medium with a circulating pump in a cooling water circulation of the engine and heating of the cooling water circulation; and
heating of at least one piston base of at least one piston reciprocating in the engine.

4. The method as defined in claim 1, wherein said at least one step includes heating fuel to be injected in the at least one combustion chamber (14) of the engine (12).

5. The method as defined in claim 4, wherein fuel injection valves (22) and other fuel conducting parts (44) of the engine (12) are heated.

6. The method as defined in claim 1, further comprising heating a lubricant circulating through the internal combustion engine (12).

7. The method as defined in claim 1, wherein said at least one step is initiated or activated prior to the direct start of the internal combustion engine.

8. The method as defined in claim 1, wherein said at least one step is performed prior to a procedure (28) required for starting the internal combustion engine (12).

9. The method as defined in claim 8, wherein said at least one step is performed when a remote control signal (28) is generated for opening a door of a motor vehicle that includes the internal combustion engine (12).

10. The method as defined in claim 1, wherein alternatively or in addition to said at least one step a starting fuel is injected in a first injection event occurring for the direct start and said starting fuel has a greater vapor pressure than that of a standard fuel used for further operation of the internal combustion engine (12).

11. The method as defined in claim 10, wherein said starting fuel is hydrogen, said hydrogen is produced by electrolysis of water during travel of a motor vehicle including the internal combustion engine, said hydrogen is stored in a pressurized hydrogen tank until subsequent start of the engine and during starting of the internal combustion engine said hydrogen is burned with air oxygen or alternatively or in addition with oxygen generated during the electrolysis to form hydrogen.

12. The method as defined in claim 1, in which in an internal combustion engine with multiple cylinders at least one combustion event (106) is initiated in a cylinder (96) in a compression cycle so that a crankshaft (86) of the internal combustion engine (12) is rotated first in a rotation direction opposite to a normal rotation direction (112) of the crankshaft so that another cylinder (98) in a working cycle experiences a compression event, and then a combustion event (114) is initiated in said another cylinder (98), which accelerates said crankshaft (86) in said normal rotation direction (112).

13. A control unit (20) for control of direct start of an internal combustion engine, said internal combustion engine having direct fuel injection into at least one air-filled combustion chamber of said engine, wherein said control unit (20) is structured to control at least one step of a method for direct start of said internal combustion engine according to one of claims 1 to 12.

14. A control unit (20) for control of direct start of an internal combustion engine, said internal combustion engine having direct fuel injection into at least one air-filled combustion chamber of said engine, wherein said control unit (20) comprises means for controlling at least one device for increasing fuel vaporization of fuel in said at least one combustion chamber when a start temperature (T) of the internal combustion engine is below a predetermined start temperature threshold (T_S).

15. A control unit (20) for control of direct start of an internal combustion engine, said internal combustion engine having direct fuel injection into at least one air-filled combustion chamber of said engine, wherein said control unit (20) comprises means for controlling at least one of
a device for heating air supplied to said at least one combustion chamber of the engine;
a device for heating fuel supplied to said at least one combustion chamber of the engine;
a heating device arranged in at least one cylinder head of the engine;
another heating device arranged in cylinder walls of the engine;
a cooling water heating device for a cooling water circulation through the engine; and
an additional heating device for heating at least one piston base of at least one piston reciprocating in the engine.
